(19) United States
(12) Patent Application Publication
(10) Pub. No.: US 2013/0016300 A1
(43) Pub. Date: Jan. 17, 2013

(54) Display Structure

(71) Applicants: Xubiao Chen, Fuqing City (CN); Gaily Feng, Fuqing City (CN)

(72) Inventors: Xubiao Chen, Fuqing City (CN); Gaily Feng, Fuqing City (CN)

(21) Appl. No.: 13/183,500

(22) Filed: Jul. 15, 2011

(51) Int. Cl. G02F 1/1333

(52) U.S. Cl. 349/58

(57) ABSTRACT

The present invention relating to a display structure is provided. The display structure comprises a liquid crystal panel, a front frame, a rear casing and a fixing box. The front frame is disposed around an outside of the liquid crystal panel. The fixing box is fastened to a surface of the liquid crystal panel, wherein the surface of the liquid crystal panel is opposite to the front frame. Each of distinct sides of the fixing box includes at least one trough. The rear casing includes a hole and at least two flexible coupling components. When the fixing box is disposed inside the hole, the coupling component can be fastened to the trough. The front frame and the rear casing encompass the liquid crystal panel and the fixing box so as to fix the liquid crystal panel and the fixing box.

### BACKGROUND OF THE INVENTION

1. Field of the Invention

The present invention relates to a display structure, more particularly to a display structure for fixing and securing multi-specification circuit boards.

2. Description of the Related Art

In recent years, a traditional CRT (cathode ray tube) monitor has been gradually replaced by a FPD (flat panel display), which is mainly because the amount of radiation released from the FPD is much less than that released from the CRT. In addition, the manufacturing cost of the FPD has been reduced significantly, which becomes one of the reasons to occupy the market for televisions or computer monitors. Since the FPD is lighter and thinner than the CRT monitor, the FPD is used widely in a railway station, a hospital, a convenience store, a movie theater, or other public places. The FPD can display messages and can be designed for advertising activities so its commercial applications are very broad.

General FPD devices are such as liquid crystal displays (LCDs), LCD TVs, All-In-One (AIO) devices, etc. Regardless of the FPD configurations, the FPD may be composed of a liquid crystal panel and a control circuit board thereof. Thus, various images can be displayed on the liquid crystal panel by means of controlling a plurality of circuit boards.

Traditionally, the circuit boards controlling the liquid crystal panel are combined with the liquid crystal panel via a metal box, which is used to secure and protect the circuit boards and prevent EMI (Electromagnetic Interference). However, its higher cost and weigh may not meet the requirements of thinness and lightness. Furthermore, the metal box is fixed and combined with the liquid crystal panel via a front frame and a rear casing of the FPD. Considering the mechanical combination strength and facility for assembling or disassembling, structural stability and convenience may face more challenges.

Therefore, how to reduce manufacturing costs and weight of the FPD to meet the requirements of thinness, improve the mechanical combination strength, and facilitate the assembly or disassembly has become an essential issue to resolve.

### SUMMARY OF THE INVENTION

Therefore, the object of the present invention is to provide a display structure, which can reduce manufacturing costs and weight of the FPD to meet the requirements of thinness, can improve the mechanical combination strength, and can facilitate the assembly or disassembly.

Accordingly, a display structure of the present invention comprises a liquid crystal panel, a front frame, a fixing box and a rear casing.

The front frame is disposed around an outside of the liquid crystal panel.

The fixing box is fastened to a surface of the liquid crystal panel. The surface is opposite to the front frame. Each of distinct sides of the fixing box includes at least one trough.

The rear casing includes a hole and at least two flexible coupling components. The coupling component is fastened to the trough when the fixing box is disposed inside the hole.

The front frame and the rear casing encompass the liquid crystal panel and the fixing box so as to fix the liquid crystal panel and the fixing box.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a display structure according to a preferred embodiment of the present invention;

FIG. 2 is a partly exploded perspective view of the display structure according to the preferred embodiment of the present invention, illustrating a fixing box can be combined with a rear casing;

FIG. 3 is a fragmentary sectional view of the display structure in the preferred embodiment, illustrating the fixing box can be combined with the rear casing; and

FIG. 4 is a fragmentary sectional view of the display structure in the preferred embodiment, illustrating the fixing box is combined with the rear casing.

### DETAILED DESCRIPTION OF THE PREFERRED EMBODIMENTS

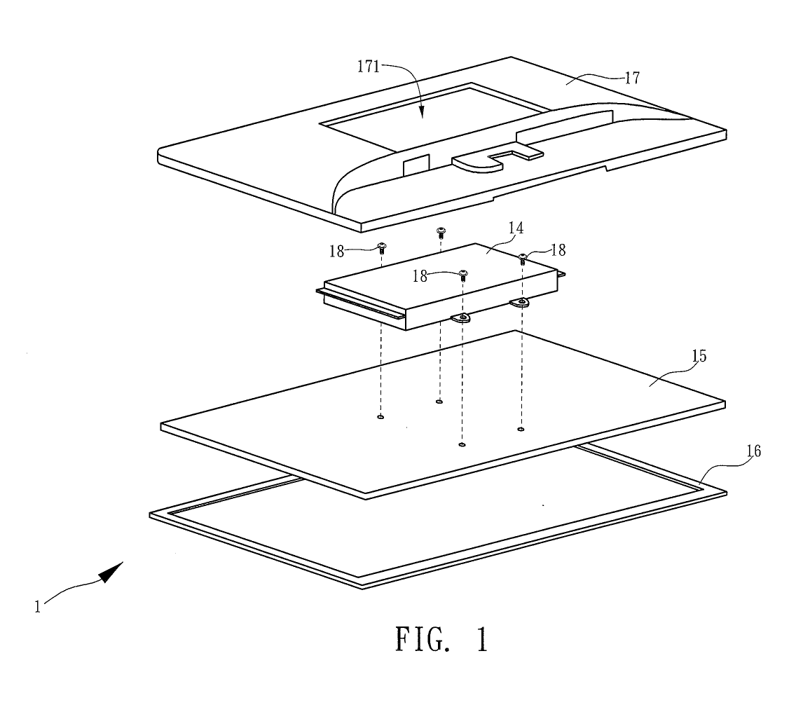

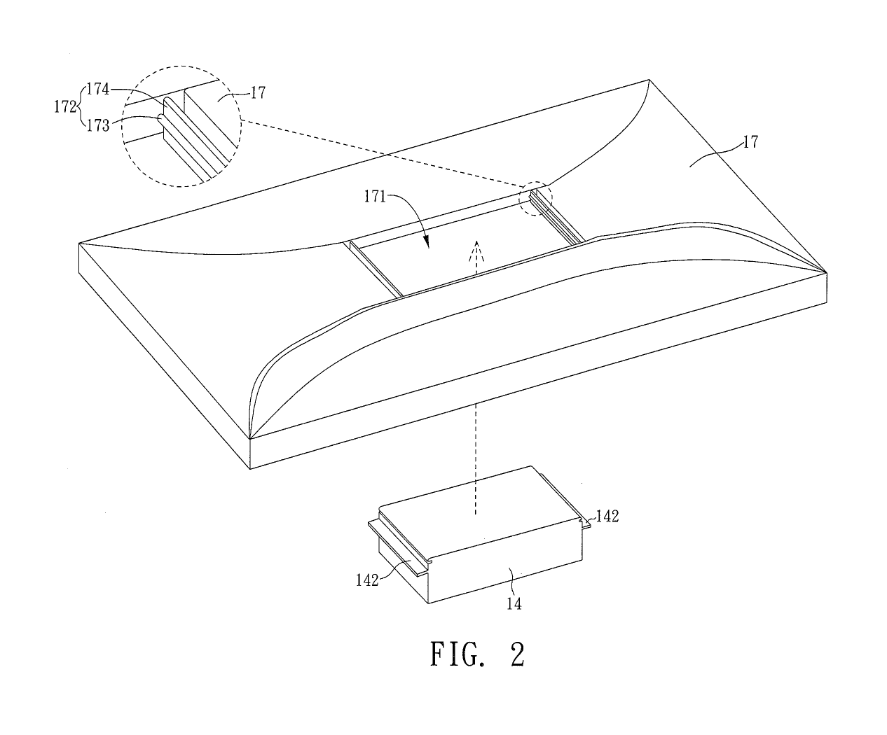

Referring to FIGS. 1, 2 and 3, a preferred embodiment of a display structure 1 according to the present invention is shown to comprise a liquid crystal panel 15, a front frame 16, a rear casing 17, and a fixing box 14. The front frame 16 is a frame structure and is disposed around and below an outer periphery of the liquid crystal panel 15. The fixing box 14 is fastened to a surface of the liquid crystal panel 15, and the surface is opposite to the front frame 16, i.e., the fixing box 14 is secured on the surface of the liquid crystal panel 15 via a plurality of screws 18. A left side of the fixing box 14 includes a trough 141 and a supporting element 142, and a right side of the fixing box 14 also includes a trough 141 and a supporting element 142. Therefore, the troughs 141 and the supporting elements 142 respectively on the left side and the right side are symmetrical. The rear casing 17 includes a through hole 171 and at least two flexible coupling components 172. The hole 171 is in a top surface of the rear casing 17 and is formed vertically therethrough. The coupling components 172 are adjacent to a periphery of the hole 171. Each of the coupling components 172 further includes a protrusion 173 and a holding portion 174. The protrusion 173 is disposed on a side of the holding portion 174. Thus, when the holding portion 174 is pressed horizontally, the protrusion 173 can be slightly swung.

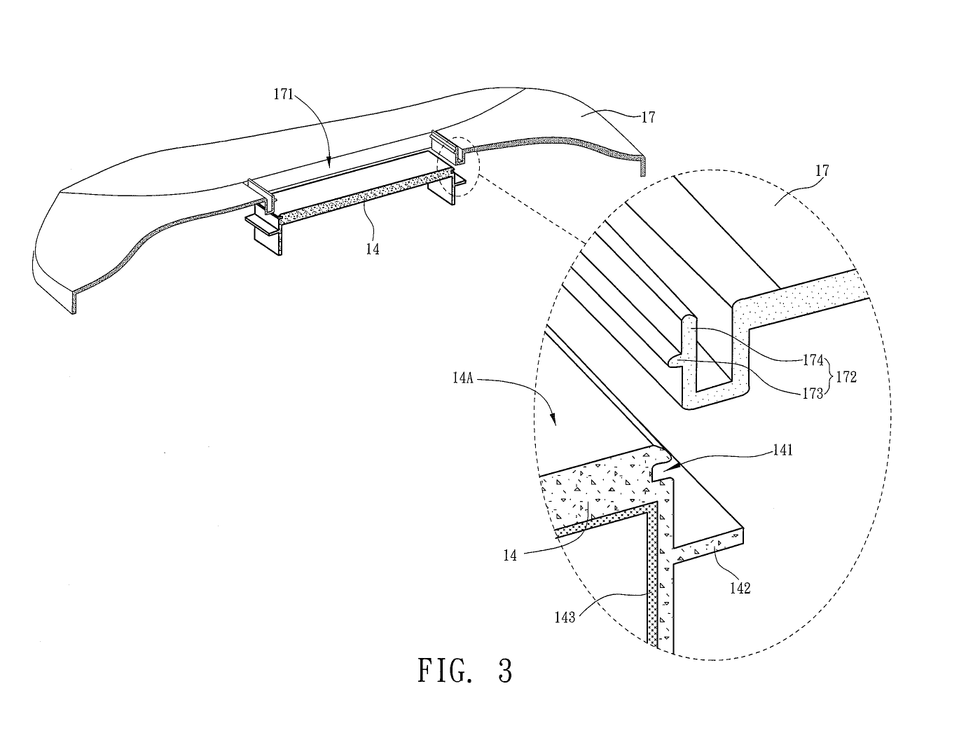

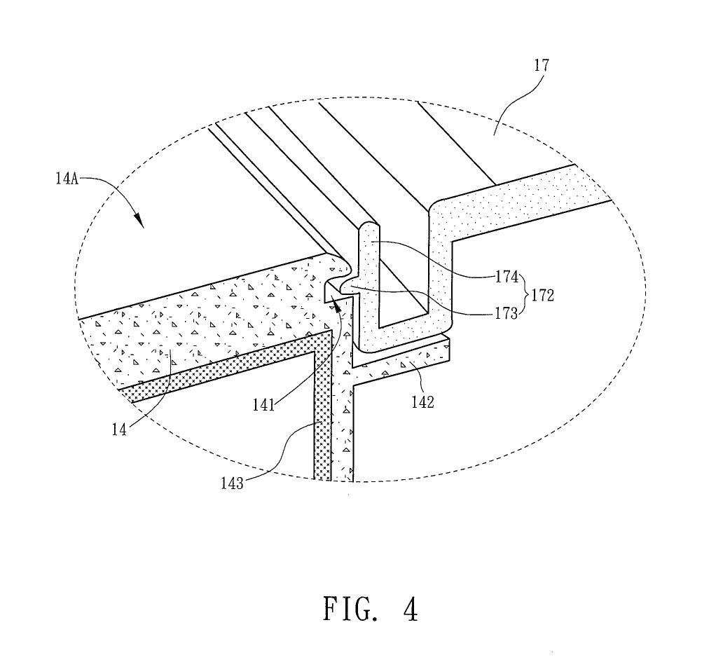

Referring to FIG. 4, in order to meet the requirements of thinness of the display structure 1 and consider its mechanical combination strength and facility for assembling or disassembling, the fixing box 14 can be combined with the rear casing 17 in the present invention. As shown in FIGS. 3 and 4, when the fixing box 14 is disposed inside the hole 171 of the rear casing 17, the coupling components 172 are fastened respectively to the troughs 14 on the left and right sides. After that, the supporting elements 142 are below and support the coupling components 172 of the rear casing 17. A top surface 14A of the fixing box 14, the top surface of the rear casing 17, and an upper surface of the coupling components 172 are aligned. In addition, in order to improve the mechanical combination strength, the protrusion 173 is received by the trough 141. In some embodiments, the protrusion 173 can tightly engage the trough 141 (interference fit). And, the fixing box 14 can be released from the rear casing 17 as long as the holding portion 174 is pressed horizontally such that the protrusion 173 is not received by the trough 141. Therefore, in the present invention, components or elements can be easily assembled and disassembled, and the mechanical combination strength can be improved effectively.

Furthermore, the fixing box 14 can accommodate a plurality of circuit boards (not shown). When the fixing box 14 is secured on the liquid crystal panel 15, the circuit boards can be fixed on the top surface of the liquid crystal panel 15 so as to control images displayed on the liquid crystal panel 15. Thus, the fixing box 14 can protect and fix the circuit boards. In some embodiments, the fixing box 14 can be made of plastic, resin, or polymer so as to reduce the weight of the display structure 1, and these materials cost less than metal.

In order to prevent EMI (Electromagnetic Interference), the fixing box 14 is provided with a protection component 143 that is made of metal material. The protection component 143 has a sheet, plate, or mesh-like structure, such that the protection component 143 is disposed fully on an inner surface or an outer surface of the fixing box 14 or is embedded in the fixing box 14 so as to encompass the circuit boards in the fixing box 14. This can prevent external electromagnetic wave, noise, or other strong interference sources, which interferes with the normal operation of these circuit boards. In some embodiments, the protection component 143 can be disposed on the inner surface of the fixing box 14 and can be grounded to provide better EMI prevention performance.

After the fixing box 14 accommodates the circuit boards, the fixing box 14 is secured on the liquid crystal panel 15. Then, the fixing box 14 is combined with the rear casing 17 and is disposed inside the hole 171 of the rear casing 17. The rear casing 17, the fixing box 14, and the liquid crystal panel 15 are arranged along the top/bottom direction and are combined. Next, the rear casing 17 is combined with the front frame 16, such that the front frame 16 and the rear casing 17 encompass the liquid crystal panel 15 and the fixing box 14 so as to fix the liquid crystal panel 15 and the fixing box 14. This can achieve the manufacturer's mechanical combination strength.

In sum, the display structure 1 of the present invention can reduce the manufacturing costs and weight, can meet the requirements of thinness, can improve the mechanical combination strength, and can facilitate the assembly or disassembly, which shows great potential.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A display structure comprising:
a liquid crystal panel;
a front frame disposed around an outside of the liquid crystal panel;
a fixing box fastened to a surface of the liquid crystal panel, the surface being opposite to the front frame, each of distinct sides of the fixing box including at least one trough; and
a rear casing including a hole and at least two flexible coupling components, the coupling component fastened to the trough when the fixing box is disposed inside the hole;
wherein the front frame and the rear casing encompass the liquid crystal panel and the fixing box so as to fix the liquid crystal panel and the fixing box.

2. The display structure as claimed in claim 1, wherein the fixing box is secured on the liquid crystal panel via a plurality of screws.

3. The display structure as claimed in claim 1, wherein the coupling components are adjacent to a periphery of the hole.

4. The display structure as claimed in claim 1, wherein the fixing box is provided with a protection component that is made of metal material.

5. The display structure as claimed in claim 4, wherein the protection component has a sheet, plate, or mesh-like structure.

6. The display structure as claimed in claim 4, wherein the protection component is disposed on an inner surface or an outer surface of the fixing box or is embedded in the fixing box.

7. The display structure as claimed in claim 1, wherein the fixing box further includes a supporting element, and the supporting element supports the rear casing when the coupling component fastened to the trough.

8. The display structure as claimed in claim 7, wherein the supporting element supports the coupling component of the rear casing.

9. The display structure as claimed in claim 1, wherein the coupling component further includes a protrusion, and the protrusion is received by the trough when the coupling component fastened to the trough.

10. The display structure as claimed in claim 9, wherein the coupling component further includes a holding portion, the protrusion is disposed on a side of the holding portion, and the protrusion can be slightly swung when the holding portion is pressed.
